(19) United States
(12) Patent Application Publication
(10) Pub. No.: US 2026/0042435 A1
(43) Pub. Date: Feb. 12, 2026

(54) METHOD FOR DETECTING A STATE OF A BRAKE, BRAKE AND BRAKE SYSTEM HAVING A BRAKE

(71) Applicant: KNORR-BREMSE SYSTEME FÜR SCHIENENFAHRZEUGE GMBH, Munich (DE)

(72) Inventors: Alexander SÜSSMANN, Munich (DE); Alexander JUNG, Gauting (DE); Sebastian REHBERGER, Freising (DE)

(21) Appl. No.: 19/100,168

(22) PCT Filed: Jul. 12, 2023
(86) PCT No.: PCT/EP2023/069371

§ 371 Date: Jan. 31, 2025

(30) Foreign Application Priority Data
Aug. 3, 2022 (DE) 10 2022 208 092.0

(51) Int. Cl. B60T 17/22; B61H 5/00; B61H 13/20; B61H 13/34; B61H 15/00; F16D 66/00; F16D 66/02

(52) U.S. Cl. CPC B60T 17/228; B61H 5/00; B61H 13/20; B61H 13/34; B61H 15/00; F16D 66/026; F16D 2066/003; F16D 2066/005; F16D 2066/006

(57) ABSTRACT

A method for detecting a state of a brake, a brake and a brake system having such a brake, wherein an action element of a brake actuator is moved in a direction in which a friction element connected to the action element is moved in a direction of action towards an element to be braked; wherein, as a first key position, a position of the action element is detected, in which, by an increase in force, a contacting of the friction element on the element to be braked is identified.

### CROSS REFERENCE AND PRIORITY CLAIM

This patent application is a U.S. National Phase of International Patent Application No. PCT/EP2023/069371 filed Jul. 12, 2023, which claims priority to German Patent Application No. 10 2022 208 092.0, the disclosure of which being incorporated herein by reference in their entireties.

### FIELD

Disclosed embodiments relate to a method for detecting a state of a brake, to a brake, and to a brake system with a brake, in particular in conjunction with rail vehicles.

### BACKGROUND

Determining wear of friction material in disk brakes, namely the wear of the brake disk and the brake lining, has up to now customarily been carried out in the field of rail vehicles by visual assessment by maintenance personnel, which is associated with great effort.

Wear of the friction material can also be measured, however, by image processing units (“train scanners”) installed in a stationary manner in the track bed or sensors which are installed in the vehicle or in its brake actuator. The image processing units pose the problems, however, that high costs arise and, as has been mentioned, they are stationary and therefore inflexible. The sensors are likewise associated with high costs and, moreover, are susceptible to faults.

A further possibility for determining the wear of the friction material is formed by wear calculation programs which utilize system variables determined from measured variables, such as brake forces and vehicle speeds, for instance, in order to calculate the wear based on converted brake energy in a model-based manner. These calculations can be highly imprecise, however.

Moreover, functioning of a wear adjustment apparatus in order to ensure braking despite the wear can be determined only if the required brake effect is no longer present.

### SUMMARY

Therefore, disclosed embodiments eliminate the above disadvantages, and provide a method and a brake which determine a state of the brake in an inexpensive and reliable manner.

### BRIEF DESCRIPTION OF FIGURES

In the following text, disclosed embodiments are explained with reference to the appended drawings, in which, in particular:

FIG. 1 shows a basic illustration of a brake system with an electromechanical brake,

FIG. 2 shows basic illustrations of a piston position and a piston force of a piston of an electromechanical brake actuator of the electromechanical brake in a case without brake wear,

FIG. 3 shows basic illustrations of the piston position and the piston force in a case with brake wear,

FIG. 4 shows basic illustrations of the piston position in a case of an adjustment after brake wear, and

FIG. 5 shows basic illustrations of the piston position in a case of a thermal expansion of the electromechanical brake.

### DETAILED DESCRIPTION

In accordance with various disclosed embodiments, a method for detecting a state of a brake includes:
moving an active member of a brake actuator in a direction, in which a friction element which is connected to the active member is moved in an active direction toward an element to be braked;
detecting a position of the active member, in which the friction element bearing against the element to be braked is detected by a rise in force on the active member beginning, as first corner position.

These operations form the basis for detecting a state of the brake, without additional sensors having to be installed in the brake actuator, in particular without sensors of this type being required in the region of the element to be braked, namely in the region of a brake disk, and in the region of the brake element, namely a brake lining.

An electromechanical drive as the drive has positional and force measurement. For example, the position can be determined indirectly via the rotation of the motor. An angle sensor is required in the case of electrically commutated DC motors. The position of the brake cylinder can be extrapolated via the rotation of the motor and the transmission ratio of the actuating member. Measurement of the force of the brake cylinder is required in rail vehicle brake systems to regulate the brake application force, wherein the force of the brake cylinder is determined in electromechanical brake systems via dedicated force sensors or via a motor torque. The motor torque can be determined via the phase current, wherein the phase current is as a rule a known variable. In the case of pneumatic or hydraulic cylinders, corresponding sensors can be provided thereon or in a brake mechanism.

In one advantageous refinement of the method, in which a travel of the active member from a rest position of the active member as far as the first corner position corresponds with an associated spacing of the friction element from the element to be braked, the wear is compensated for in such a way that the associated spacing is situated within a predefined tolerance range. This refinement of the method includes: determining a functionality of the wear adjustment apparatus by determining that the associated spacing is situated within the predefined tolerance range after a predefined number of brake operations via the travel of the active member.

If it is determined via the travel of the active member from the rest position of the actuator as far as the first corner position after the predefined number of brake operations that the predefined spacing is situated within the predefined tolerance range, a functionality of the adjusting mechanism, that is to say ensuring the adjustment and therefore reliable retardation of the rail vehicle, can be determined as a result.

In a further advantageous refinement of the method, the method includes:
continuing the movement of the active member and the friction element connected to it in the active direction in order to produce a brake operation;
moving the active member and the friction element connected to it counter to the active direction in order to end the brake operation;
detecting a position of the active member, in which the lifting of the friction element from the element to be braked is detected by a decrease in force on the active member ending, as second corner position.

These operations form the basis for detecting further states of the brake, without additional sensors having to be installed in the brake actuator, in particular without them being required in the region of the element to be braked, in particular in the region of a brake disk, and in the region of the brake element, in particular a brake lining.

In one advantageous refinement of the method, wear of the friction element and the element to be braked is determined by calculating the positional difference between the first corner position and the second corner position.

Here, the wear of the friction element and the element to be braked occurring currently during the last brake operation can specifically be determined, without, for example, sensors in the friction element or image processing apparatuses having to be provided. Here, the wear state of the entire friction material is determined. A division of the wear of the element to be braked and the friction element can be determined from empirical values.

In accordance with a further advantageous refinement of the method, a total wear of the friction element and the element to be braked is determined by adding together the wear of the friction element and the element to be braked after a plurality of brake operations.

It is possible by way of this operation to determine the total wear, for example since a replacement of the friction material, in order to signal preventative maintenance, for example.

In the case of a further advantageous refinement of the method, the total wear of the friction element and the element to be braked is determined after each brake operation.

This makes a precise determination of a characteristic of the wear possible, even under boundary conditions which are detected, for example, such as the speed or the weight of the rail vehicle, for example.

In the case of a further advantageous refinement of the method, a thermal expansion of the friction element and the element to be braked is determined by calculating the positional difference between the first corner position and the second corner position.

By way of the determination of the thermal expansion of the friction element and the element to be braked, wherein the entire expansion of the two elements is determined, it is possible, for example, to estimate thermal loading of the brake.

In accordance with various disclosed embodiments, a brake has a brake actuator, a friction element, an element to be braked, and a brake mechanism which has the brake actuator and which is configured to move the friction element for a brake operation in an active direction toward the element to be braked in a manner which is dependent on a movement of an active member of the brake actuator, and to move the friction element away from the element to be braked counter to the active direction in order to end the brake operation, and the brake actuator is configured to detect, via the brake mechanism, a force, exerted on the friction element along the active direction, and a position of the friction element along the active direction by a force, exerted on an active member of the brake actuator, and a position of the active member.

By way of this brake, its state can be detected without additional sensors in the region of the element to be braked, in particular in the region of a brake disk, and in the region of the brake element, in particular a brake lining, or image processing units being required.

In accordance with one advantageous refinement of the brake, it is configured to carry out an abovementioned method, by way of which the abovementioned advantages can be achieved.

In the case of another advantageous refinement of the brake, wherein the brake mechanism has a wear adjustment apparatus, the brake is configured to carry out one of the abovementioned methods with compensation of the wear, by way of which the abovementioned advantages can be achieved.

In accordance with various disclosed embodiments, a brake system has a brake and a control apparatus which is configured to actuate the brake, wherein the control apparatus is configured to evaluate and to process the detected first corner position and second corner position.

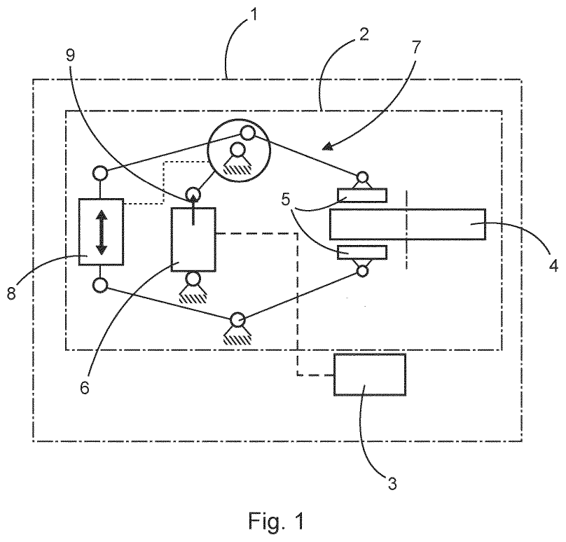

FIG. 1 shows a basic illustration of a brake system 1 with an electromechanical brake 2 and a control apparatus 3. In alternative embodiments, the brake is not configured as an electromechanical brake, but rather as a pneumatic or hydraulic brake.

The electromechanical brake 2 has a brake disk as an element 4 to be braked, and brake linings as friction elements 5. Furthermore, the electromechanical brake 2 has an electromechanical brake actuator 6 which is connected by an eccentric shaft to a brake mechanism 7 of the electromechanical brake 2 and to a wear adjustment apparatus 8. In alternative embodiments, the brake disk can also be replaced by a wheel body or a brake drum. In further alternative embodiments, only one friction element 5 is provided, or more than two friction elements 5 are provided. In the alternative embodiments, in which the brake is configured as the pneumatic or hydraulic brake, a pneumatic or hydraulic brake actuator is correspondingly provided.

The electromechanical brake actuator 6 is configured in this embodiment as an electromechanical cylinder with a piston rod as an active member 9. In alternative embodiments, the electromechanical brake actuator 6 can also be configured, for example, as a rotary cylinder. The position of the piston rod is determined indirectly via the rotation of the motor of the electromechanical brake actuator 6 via an angle sensor, wherein the position of the brake cylinder is extrapolated via the rotation of the motor and the transmission ratio of the actuating member. In alternative embodiments, the position of the active member 9 can also be detected via displacement sensors on the pneumatic or hydraulic cylinders or at another point in the brake mechanism 7, for example on an eccentric which is described in the following text.

By way of the extension of the piston rod, an eccentric is deflected via a lever, which eccentric is supported within the brake mechanism 7 in such a way that the friction element 5 which is connected directly to the eccentric is moved in an active direction toward the element 4 to be braked. If this friction element 5 is supported on the element 4 to be braked, the entire brake mechanism 7 is displaced, in the case of a continued extension of the piston rod, in such a way that the other friction element 5 also moves in its active direction toward the element 4 to be braked and bears against the latter. In the case of a subsequent further extension of the piston rod, the brake force of the electromechanical brake 2 is generated in a brake operation. In order to end the brake operation, the piston rod retracts again into the electromechanical brake actuator 6, as a result of which the friction elements 5 are moved away from the element 4 to be braked.

The electromechanical brake actuator 6 is firstly actuated by way of the control apparatus 3, in order to generate a required brake force. Secondly, by a force, exerted on the active member 9 of the electromechanical brake actuator, and a position of the active member 9, the electromechanical brake actuator 6 supplies the control apparatus 3 with data about a force, exerted along the active direction on the friction element 5, and about a position of the friction element 5 along the active direction. In alternative embodiments, the data are not provided to the control apparatus 3 which actuates the electromechanical brake actuator 6, but rather to a separate evaluation device. In further alternative embodiments, the control apparatus 3 is integrated into the electromechanical brake actuator 6. In other alternative embodiments, the data with regard to the position and the force are not provided by the electromechanical brake actuator 6, but rather by sensors within the brake mechanism 7.

The wear adjustment apparatus 8 detects if the element 4 to be braked and/or the friction elements 5 are/is subject to wear, and automatically carries out a compensation of the wear, as known in the prior art. The compensation of the wear takes place either during the movement of the friction elements 5 toward the element 4 to be braked or during the movement of the friction elements 5 away from the element 4 to be braked.

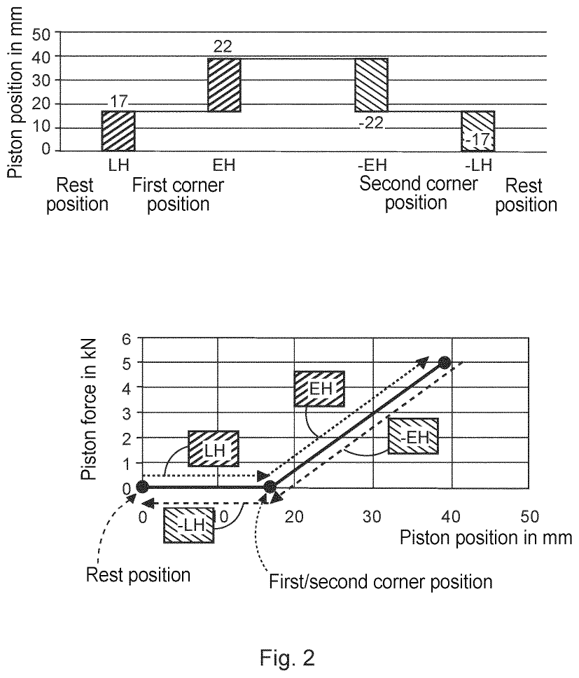

FIG. 2 shows basic illustrations of a piston position and a piston force of a piston as the active member 9 of the electromechanical brake actuator 6 of the electromechanical brake 2 in a case without brake wear.

In the upper bar chart, piston positions, that is to say travels of the active member 9, are shown in a manner which is dependent on their action.

Starting from the piston position 0 mm as a rest position of the active member 9, an idle stroke LH is carried out as far as an extended piston position of 17 mm. The idle stroke LH is a stroke which has to be moved by the piston from the rest position, in order to bring the friction elements 5 to bear against the element 4 to be braked.

Following the idle stroke LH, what is known as an elastic stroke EH is carried out. The elastic stroke EH is a stroke which has to be moved by the piston, in order to compensate for an elasticity of the brake system during a build-up of force between the friction elements 5 and the element 4 to be braked. The elasticity of the brake system is an approximately constant, in particular linear, system property. The elastic stroke EH is dependent on the brake force and is 22 mm in this example. The brake operation is carried out by the elastic stroke EH.

In order to end the brake operation, the elastic stroke is carried out in the reverse direction −EH once again by a piston stroke of 22 mm and, following this, a piston stroke of 17 mm is once again carried out as the reversed idle stroke −LH, with the result that the friction elements 5 are again situated in their original position and the piston as the active member 9 is in its rest position again.

A piston force characteristic depending on the piston position can be seen in the lower diagram. The force/displacement characteristic is shown by the solid thick line. For illustrative reasons, the idle strokes LH, −LH and the elastic strokes EH, −EH are illustrated next to the solid thick line, but actually lie on the solid thick line. As in the upper diagram, it can also be seen here that the idle stroke LH takes place as far as a piston position of 17 mm, wherein no force is applied to the friction elements 5 and therefore the piston force also remains at “0”. As soon as the friction elements 5 come into contact with the element 4 to be braked, the piston force rises during the elastic stroke EH. The position of the piston, at which the friction elements 5 bear against the element 4 to be braked, that is to say the piston force begins to rise, is called the first corner position. In this case, the piston is extended by 22 mm as far as a piston position of 39 mm, in order to achieve the currently desired brake force. In order to end the brake operation, the friction elements 5 are moved in the other direction, as a result of which the piston force once again decreases, as far as the piston position, at which the friction elements 5 lift off from the element 4 to be braked, with the result that the piston force once again remains constant at “0”. The position of the piston, at which the friction elements 5 lift off from the element 4 to be braked, from which therefore the piston force then remains constant at “0”, is called the second corner position. In the case without wear, the second corner position therefore corresponds to the first corner position.

The first corner position is therefore detected by detecting a force rise beginning. The second corner position is detected by detecting a constant force characteristic after a decrease in the force.

The force characteristics are shown here in an idealized manner as straight lines. In reality, however, due to friction and inertia of the components involved, the force characteristics have an unsteady characteristic which is smoothed and/or averaged by way of corresponding algorithms, in order for it to be possible for it to be evaluated.

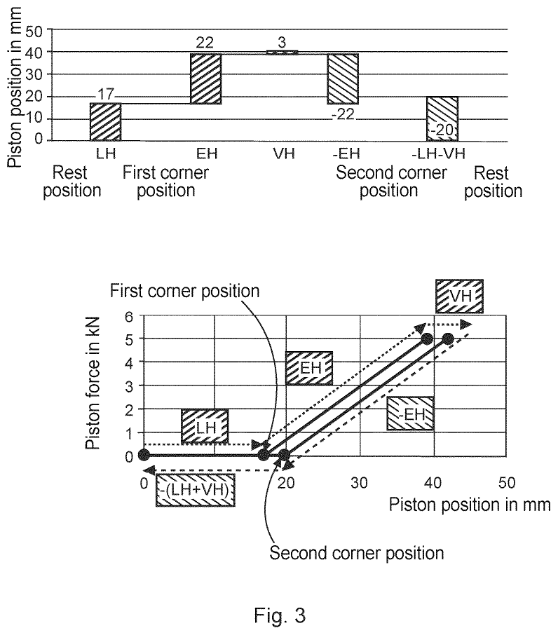

FIG. 3 shows basic illustrations of the piston position and the piston force in a case with brake wear.

As also already be seen in the diagrams in FIG. 2, an idle stroke LH is carried out as far as a piston position of 17 mm, and an elastic stroke of 22 mm is carried out, that is to say as far as a piston position of 39 mm. On account of, for instance, a brake operation which lasts for a relatively long time, for example in the case of relatively long downhill traveling, the friction elements 5 and/or the element 4 to be braked are/is subject to wear, with the result that, in order to maintain the necessary brake force, it is required to carry out an additional wear stroke VH. The wear stroke VH is a stroke which has to be moved by the piston, in order to compensate during a brake operation for the wear of the friction material, that is to say of the friction elements 5 and the element 4 to be braked, in such a way that the desired brake force is maintained. In this example, the wear stroke VH is 3 mm, that is to say as far as a piston stroke of 42 mm. In order to end the brake operation, the friction elements 5 are then moved again in the other direction, as a result of which the piston force once again decreases up to the piston position, at which the friction elements 5 lift off from the element 4 to be braked. Since the elastic stroke EH/−EH of 22 mm is the constant system property, the friction elements 5 therefore lift off from the element 4 to be braked in a piston position of 20 mm which is the second corner position here. Following this, the active member 9 moves again into the rest position, wherein 20 mm, namely the travel of 17 mm of −LH and the travel of 3 mm of −VH, are covered. The second corner position therefore differs from the first position by 3 mm in this case, which corresponds to the wear stroke VH and corresponds with the wear of the element 4 to be braked and the friction elements 5.

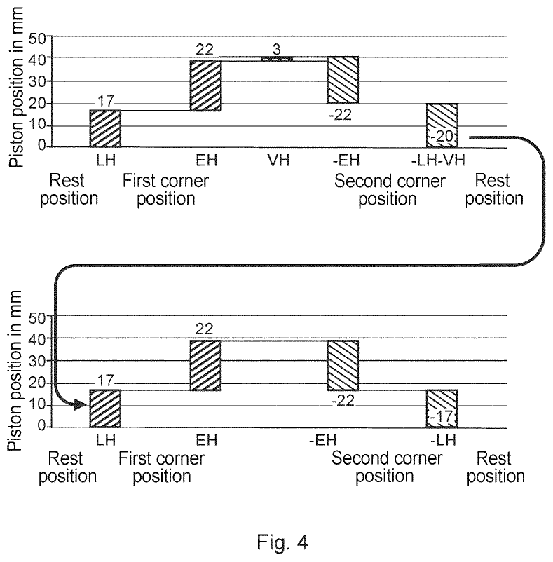

FIG. 4 shows basic illustrations of the piston position in a case of an adjustment after the brake wear.

The illustration of the upper bar chart corresponds to that of the upper bar chart of FIG. 3; accordingly, wear of the element 4 to be braked and the friction elements 5 occurs during the brake operation. It can also be seen here that the return stroke corresponds to −LH-VH, that is to say −20 mm, and the wear which corresponds with 3 mm of piston travel is therefore not yet compensated for. Following this brake operation, shown in the lower bar chart, a next brake operation which has fundamentally already been depicted in FIG. 2 takes place.

In the lower diagram of FIG. 4, the idle stroke LH is likewise 17 mm, from which it can be seen that the wear of the last brake operation has been compensated for during the idle stroke LH for the next brake operation by way of the wear adjustment apparatus 8, with the result that the idle stroke LH corresponds to the customary idle stroke LH of 17 mm. As an alternative, there is also the possibility that the wear adjustment apparatus 8 has already compensated for the wear during the return stroke −LH-VH, wherein this return idle stroke −LH would then once again be 17 mm. Moreover, there is the possibility as an alternative that the wear is compensated for in part during the return idle stroke −LH and in part during the idle stroke LH during the next brake operation.

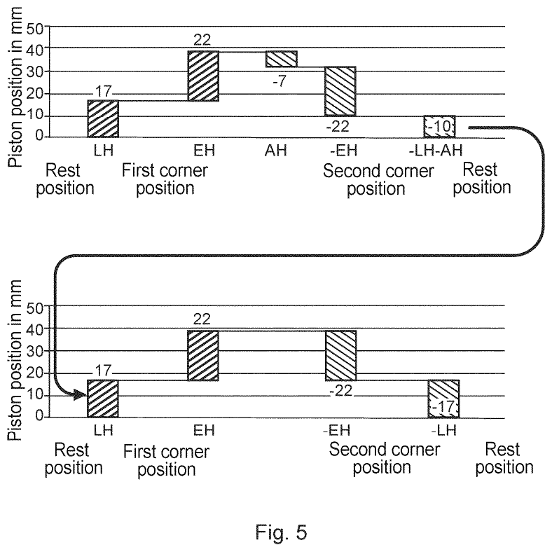

FIG. 5 shows basic illustrations of the piston position in a case of a thermal expansion of the electromechanical brake.

A first part of the brake operation until the currently desired brake action is reached also corresponds in this illustration to the brake operations shown in FIGS. 3, 4 and 5. The idle stroke LH of 17 mm piston stroke is first of all carried out, and then the elastic stroke EH of 22 mm.

During the brake operation, thermal expansions of the electromechanical brake 2, in particular of the friction element 5 and the element 4 to be braked, occur on account of kinetic energy which is converted into heat. Since these expansions lead to an increase in the brake force, the electromechanical brake actuator 6 is actuated in such a way that it retracts its active member 9 again by what is known as an expansion stroke AH, in order to decrease the brake force to the actually required brake force. The expansion stroke AH is therefore a stroke which has to be moved by the piston, in order to keep brake application forces constant as a consequence of the thermal expansion. In this example, the expansion stroke is −7 mm.

As can be seen from the following bars, the elastic stroke −EH is also 22 mm as an approximately constant system property in this case. The return stroke from the second corner position therefore results from the idle stroke −LH which is decreased by the expansion stroke AH.

This expansion stroke AH is not compensated for, however, but rather the original state is re-established by cooling of the components of the electromechanical brake 2, with the result that the idle stroke LH which is shown in the lower bar chart is once again 17 mm in the case of the next brake operation.

During operation, a method which is described in the following text for detecting a state of the electromechanical brake is carried out. In accordance with the strokes shown in FIGS. 2 to 5, the active member 9 of the electromechanical brake actuator 6 is moved in a direction, in which the friction element 5 which is connected to the active member 9 is moved in an active direction toward the element 4 to be braked. A position of the active member 9, in which the friction element 5 bearing against the element 4 to be braked is detected by a force rise on the active member 9 beginning, is called a first corner position, and the movement of the friction element 5 is continued in the active direction in order to generate the brake operation. In order to end the brake operation, the friction element 5 is moved counter to the active direction. As a result, the force on the active member 9 is also reduced, and a position of the active member 9, in which the lifting off of the friction element 5 from the element 4 to be braked is detected by a force decrease on the active member ending, is detected as a second corner position. By these two corner positions, the state of the electromechanical brake can be detected.

By way of calculating the positional difference of the active member 9 at the first corner position and the second corner position, the wear of the friction elements 5 and the element 4 to be braked can be determined. If there is no positional difference between the first corner position and the second corner position, it can be seen from this that no noticeable wear has arisen during the last brake operation.

In addition to determining the wear during a single brake operation, there is also the possibility to determine total wear by adding together the wear of the friction elements 5 and the element 4 to be braked. In order to carry out the determination of the total wear as exactly as possible, this is determined after each brake operation is ended. In alternative embodiments, this total wear is determined after a predefined number of brake operations or, for example, after a predefined time duration has expired.

If the wear of the friction elements 5 and the element 4 to be braked exceeds a predefined limit value, the wear is automatically compensated for by the wear adjustment apparatus 8. In the present embodiment, this takes place via an automatic mechanical actuation of the wear adjustment apparatus 8 within the brake mechanism 7. In alternative embodiments, this actuation can also take place pneumatically, or the determination of the wear of the friction elements 5 and the element 4 to be braked by the first and second corner position is used, in order to actuate the wear adjustment apparatus in order to compensate for the wear.

As has already been described above, this compensation can take place during the return stroke of the friction elements 5 lifted off from the element 4 to be braked or during the idle stroke LH of the friction elements 5 to the element 4 to be braked of the next brake operation. Moreover, there is also the possibility that the compensation takes place in part during the return stroke −LH and in part during the idle stroke LH of the following brake operation. As an alternative, it is also possible for a compensation to not take place immediately, but rather during one of the next brake operations or during several of the next brake operations, as long as it is ensured that the wear does not lead to a functional impairment.

A travel of the active member 9 from the rest position of the active member 9 as far as the first corner position corresponds with an associated spacing of the friction elements 5 from the element 4 to be braked, wherein the wear is compensated in such a way that the spacing is situated within a predefined tolerance range. In alternative embodiments, reference is not made to the predefined tolerance range, but rather the wear is always compensated for by a fixed dimension.

If the wear is compensated in such a way that the spacing is situated within the predefined tolerance range, it is possible to determine a functionality of the wear adjustment apparatus 8 by determining that the associated spacing is situated within the predefined tolerance range after a predefined number of brake operations, via the travel of the active member 9 from the rest position of the active member 9 as far as the first corner position. There is also the possibility here as an alternative for the functionality of the wear adjustment apparatus 8 to be determined only via the first corner position, without determining the wear of the friction element 5 and the element 4 to be braked via the first corner position and second corner position.

Moreover, there is the possibility to determine a thermal expansion of the friction elements 5 and the element 4 to be braked overall by calculating the positional difference between the first corner position and the second corner position before and after a brake operation.

Although the present invention has been described with reference to certain features and embodiments, it is obvious that different modifications and combinations thereof can be performed without departing from the spirit and scope of the invention. The description and the drawings are accordingly to be considered to be merely an illustration of the invention as defined by the appended claims, and are intended to cover all modifications, variations, combinations or equivalents which fall within the field of application of the present invention.

### LIST OF DESIGNATIONS

1 Brake system
2 Electromechanical brake
3 Control apparatus
4 Element to be braked
5 Friction element
6 Electromechanical brake actuator
7 Brake mechanism
8 Wear adjustment apparatus
9 Active member
LH, −LH Idle stroke
EH, −EH Elastic stroke
VH Wear stroke
AH Expansion stroke

1. A method for detecting a state of a brake for a rail vehicle, the method comprising:
moving an active member of a brake actuator in a direction, in which a friction element which is connected to the active member is moved in an active direction toward an element to be braked; and
detecting, as a first corner position, a position of the active member, in which the friction element bearing against the element to be braked is detected by a rise in force beginning.

2. The method of claim 1, wherein a travel of the active member from a rest position of the active member as far as the first corner position corresponds with an associated spacing of the friction element from the element to be braked, and wherein the method further comprises:
compensating for wear of the friction element and of the element to be braked such that the associated spacing is situated within a predefined tolerance range;
determining a functionality of a wear adjustment apparatus for the automatic compensation of the wear by determining whether the associated spacing is situated within the predefined tolerance range after a predefined number of brake operations via the travel of the active member.

3. The method of claim 1, further comprising:
continuing the movement of the active member and the friction element connected thereto in the active direction to produce a brake operation;
moving the active member and the friction element connected thereto counter to the active direction to end the brake operation;
detecting, as a second corner position, a position of the active member, in which the lifting of the friction element from the element to be braked is detected by a decrease in force ending.

4. The method of claim 3, further comprising:
determining wear of the friction element and the element to be braked by calculating a positional difference between the first corner position and the second corner position.

5. The method of claim 4, further comprising:
determining total wear of the friction element and the element to be braked by adding together the wear of the friction element and the element to be braked after a plurality of brake operations.

6. The method of claim 5, wherein the total wear of the friction element and the element to be braked is determined after each brake operation.

7. The method of claim 6, wherein the total wear is compensated for at least partially during removal of the friction element from the element to be braked.

8. The method of claim 5, wherein the total wear is compensated for at least partially during the movement of the friction element toward the element to be braked.

9. The method of claim 3, further comprising: determining a thermal expansion of the friction element and the element to be braked by calculating the positional difference between the first corner position and the second corner position.

10. A brake for a rail vehicle, the brake comprising:
a brake actuator;
a friction element;
an element to be braked; and
a brake mechanism, which has the brake actuator, and which is configured to:
move the friction element for a brake operation in an active direction toward the element to be braked in a manner which is dependent on a movement of an active member of the brake actuator, and
move the friction element away from the element to be braked counter to the active direction in order to end the brake operation,
wherein the brake mechanism is configured to detect a force, exerted on the friction element along the active direction, and
wherein the brake mechanism is configured to detect a position of the friction element along the active direction by a force, exerted on an active member of the brake mechanism, and a position of the active member.

11. The brake of claim 10, wherein the brake is configured to detect a state of a brake for a rail vehicle by:
moving the active member of the brake actuator in a direction, in which the friction element which is connected to the active member is moved in the active direction toward the element to be braked; and
detecting, as a first corner position, a position of the active member, in which the friction element bearing against the element to be braked is detected by a rise in force beginning.

12. The brake of claim 11, wherein
the brake mechanism has a wear adjustment apparatus, and
the brake is configured to:
wherein a travel of the active member from a rest position of the active member as far as the first corner position corresponds with an associated spacing of the friction element from the element to be braked, and
wherein the wear adjustment apparatus compensates for wear of the friction element and of the element to be braked such that the associated spacing is situated within a predefined tolerance range, and
wherein the wear adjustment apparatus determines a functionality of a wear adjustment apparatus for the automatic compensation of the wear by determining whether the associated spacing is situated within the predefined tolerance range after a predefined number of brake operations via the travel of the active member.

13. A brake system comprising:
a brake including a brake actuator, a friction element, an element to be braked, and a brake mechanism, which has the brake actuator, and which is configured to:
move the friction element for a brake operation in an active direction toward the element to be braked in a manner which is dependent on a movement of an active member of the brake actuator, and
move the friction element away from the element to be braked counter to the active direction in order to end the brake operation,
wherein the brake mechanism is configured to detect a force, exerted on the friction element along the active direction, and
wherein the brake mechanism is configured to detect a position of the friction element along the active direction by a force, exerted on an active member of the brake mechanism, and a position of the active member,
wherein the brake mechanism is configured to detect a state of a brake for a rail vehicle by:
moving the active member of the brake actuator in a direction, in which the friction element which is connected to the active member is moved in the active direction toward the element to be braked; and
detecting, as a first corner position, a position of the active member, in which the friction element bearing against the element to be braked is detected by a rise in force beginning,
continuing the movement of the active member and the friction element connected thereto in the active direction to produce a brake operation,
moving the active member and the friction element connected thereto counter to the active direction to end the brake operation,
detecting, as a second corner position, a position of the active member, in which the lifting of the friction element from the element to be braked is detected by a decrease in force ending; and
a control apparatus configured to actuate the brake and configured to evaluate and to process the detected first corner position and the second corner position.
